(19) United States
(12) Patent Application Publication
(10) Pub. No.: US 2010/0287815 A1
(43) Pub. Date: Nov. 18, 2010

(54) METHOD FOR CONTROLLING HARMFUL RODENTS IN AGRICULTURAL ENTERPRISES

(75) Inventors: Stefan ENDEPOLS, Koln (DE); Karl-Ludwig Ziebell, Dusseldorf (DE); Sonja Nicole Ziebell, Dusseldorf (DE); Horst Karl Ziebell, Bad Salzuflen (DE); Anna Lene Ziebell, Bad Salzuflen (DE); Nicole Klemann, Warendorf (DE)

Correspondence Address: Baker Donelson Bearman, Caldwell & Berkowitz, PC, 920 Massachusetts Ave, NW, Suite 900, Washington, DC, 20001, US

(73) Assignee: BAYER CROPSCIENCE AG, MONHEIM (DE)

(21) Appl. No.: 12/841,116

(22) Filed: Jul. 21, 2010

Related U.S. Application Data
(63) Continuation of application No. 10/477,480, filed on Apr. 29, 2004.

(30) Foreign Application Priority Data
May 14, 2001 (DE) 101 23 415.5

(51) Int. Cl. A01M 25/00; A01M 23/00; A01M 19/00

(52) U.S. Cl. 43/58; 43/124; 43/131

(57) ABSTRACT

The present invention relates to a method for controlling harmful rodents on agricultural premises, using rodenticides.

This application is a continuation application of U.S. patent application Ser. No. 10/477,480 (the entire disclosure of which is incorporated herein by reference), filed on Apr. 29, 2004, which was filed under 35 U.S.C. 371 as a national stage application of PCT/EP2002, filed May 2, 2002, which claim priority to German Application No. 101 23 415.5 on May 14, 2001.

The present invention relates to a method for controlling harmful rodents on agricultural premises, using rodenticides.

Harmful rodents, such as rats, are an important hygiene problem with regard to epidemics, in particular in the field of animal keeping. They may act as reservoirs or vectors for a large number of pathogens, for example for diseases such as various types of enteritis, or erysipelas, dysentery and foot-and-mouth disease, inter alia. The sustained control of rats is therefore an important part of the hygiene measures to be applied to agricultural premises, in particular those where livestock is kept.

For reasons of epidemiology, a trend exists in agriculture to entrust fewer pest control agencies with the control of these vectors. Pest control measures are increasingly carried out by the farmer himself. Harmful rodents are controlled by the producer or employed staff using commercially available rodenticides, both in medium-sized farms and in large enterprises.

Rodenticides (in particular products for controlling rats) can be obtained commercially from agricultural merchants or others. As a rule, these compositions consist of cereals such as wheat or flaked oats, or they are cereal-based mixtures such as pastes and wax bars. The most frequently used active compounds are anticoagulants. As a rule, the manufacturer will provide information for the use of these compositions on the packing or in brochures.

This information recommends analyzing the infestation as the first control step. While this is impossible to carry this out by observing the rats or other harmful rodents since the animals are predominantly active during the night and have a secretive lifestyle, the usual information for users, also in brochures and publications, recommends to search for symptoms of the harmful rodents' activity. Such symptoms are described as being, inter alia, faeces, runs, signs of gnawing or disturbed soil. The bait is to be placed at such identified locations.

Even though such information and recommendations are well known and highly effective baits are available, the control of harmful rodents in animal keeping is ultimately not satisfactory. It appears that some of the harmful rodents do not eat the bait, or not enough of the bait, and survive the control measures.

Assuming that baits with appropriate characteristics are used, the frequent absence of irradication or substantial reduction of the infestation can only be explained by the fact that the bait has not been applied in the infested area in such a way that all harmful rodents of the population(s) to be controlled are capable of reaching and, as a consequence, consuming it. The conventional method of analyzing the overall infestation in terms of extent and activity distribution via indirect symptoms of the presence of harmful rodents frequently leads to an unsatisfactory result. For example, the extent of an infestation is underestimated by the farmer in a number of cases, inter alia since he searches for signs of rats only in those places which he himself frequents often.

There was a need for a method of controlling harmful rodents which is successful in controlling rodents without specifically analyzing the respective infestation with harmful rodents.

The present invention relates to a method of controlling harmful rodents on agricultural premises which is based on a simple, mechanistic procedure. An individual analysis of the specific infestation with harmful rodents is not necessary. The bait stations are arranged on the premises according to a key of the unambiguous assignment to specific, typical structural elements. These structural elements can be found on all agricultural premises and are known to the farmer. The bait stations are distributed on the basis of preexisting information which is independent of the harmful rodents.

The invention therefore relates to a method for controlling harmful rodents on agricultural premises in which
(i) in a first step information is gathered on which of the following structural elements exists at the premises in question:
   (a) buildings
   (b) animal keeping
   (c) feed stores
   (d) stacks
   (e) piles of old materials
   (f) straw/hay,
(ii) in a second step, one or more bait stations, preferably one bait station, is/are set up each of the structural elements present on the agricultural premises in question.

In a preferred embodiment, additional bait stations are arranged at the following structural elements, if present on the premises in question:
(g) ground-cover plants
(h) watercourses
(i) holes inhabited by harmful rodents.

One bait station is equipped with rodenticidal feed baits at each existing structural element, following the customary principles.

If, for example, a feed store (c) and animal keeping (b) exist, or take place, in a building (a), a total of three bait stations must be set up.

In a preferred embodiment, bait stations which are in close proximity of one another, i.e. a few meters (approximately up to 3 m), may be combined into one bait station.

Structural elements refer to the environment of harmful rodents and to the areas in which they reside or the areas they withdraw into. These are, in particular, buildings, animal keeping, feed stores, stacks, piles of old materials, straw/hay, ground-cover plants, watercourses and holes inhabited by harmful rodents.

Preferred bait sites for harmful rodents are
set up along the wall and on solid ground (i.e. so that they do not wobble);
protected from water;
covered, preferably with old material, for example wood, roof tiles, pipes, bricks, concrete blocks, tires, bait boxes;
large enough that sufficient room for movement for harmful rodents is provided under the cover, for example 25 cm in the case of rats;
inaccessible for dogs, birds, and other animals.

Bait stations for harmful rodents are preferably set up in such a way that the environment undergoes only a minimum of alteration.

Agricultural premises are installations which have agricultural, silvicultural or horticultural character and/or serve for the production, processing, storage, sale of agricultural products, including feedstuffs, and/or where animals are kept.

Preferred agricultural premises are those where animals are kept as the main business, as a second source of income or noncommercially.

Also preferred are premises on which feedstuffs are located.

Buildings are mainly dwellings, but also stores, animal houses, workshops, sheds, garages, barns or the like, each floor (upper floor (c), ground floor, basement (e)) constituting one structural element.

Animal keeping may be, for example, a closed, semi-open or open building or built-up area where, for example, horses, goats, cattle, pigs, sheep or poultry are kept.

Feed stores are, for example, feed silos, feed blenders, piles or silos of cereals, cereal blenders, tubs in which feed is stored, and the like.

Stacks are, for example, arranged stacks of timber, stacks of building materials, firewood and the like.

Piles of old materials (junk) are unarranged piles of, for example, pipes, tires, old building materials and the like.

Straw/hay refers to, for example, piles of straw or piles of hay consisting of loose or bound straw or hay, also in barns or haystacks.

Watercourses are, for example, ponds such as duckponds, fishponds, ornamental ponds, receiving bodies of water, drains and the like which are located in the area of the premises in question or directly adjacent.

Holes inhabited by harmful rodents are holes inhabited by harmful rodents such as rats and mice, in particular rats, which are already known to exist.

Ground-cover plants are, for example, shrubs which cover the ground densely and thus offer protection for harmful rodents. Preferably, bait stations are established in those ground-cover plants which are in the immediate proximity of buildings and animal houses, especially preferably those which are no further than 10 m from animal houses or buildings where feed is stored.

Harmful rodents are commensal rodents, in particular rats, such as the brown rat, or mice. The method according to the invention is especially preferably employed for controlling rats.

An aid in setting up the above-described bait distribution may be a positional sketch (cf. FIGS. 1 to 3) in which all of the abovementioned structural elements ((a) to (i)) are marked as symbols. The numbered bait stations (k) are assigned to these structural elements. The bait stations are listed in the form of a table on a datasheet, and the amount of the baits placed and supplemented according to a schedule is recorded.

In a preferred embodiment, the bait stations are checked regularly, preferably every 2 to 7 days, especially preferably every 3 to 4 days.

Depending on what is found for the individual bait stations, the following measures may be taken:
At least 50% of the bait eaten: Increase, for example double, employed amount of bait.
Less than 50% of the bait eaten: Replace by fresh bait.
Bait untouched: Halve amount of bait after 2 weeks.
Bait soiled or otherwise unusable: Replace by fresh bait.

In a preferred embodiment, the harmful rodents are controlled simultaneously on neighbouring premises.

When testing the method, it emerged, surprisingly, that the analysis of the infestation with the harmful rodents in question can be dispensed with entirely. What is particularly surprising is that even stubborn, concealed infestation with rats was irradicated without previously analyzing the infestation and without deviating from the principle according to the invention. Thus, an important source of error in the control of harmful rodents, namely underestimating the infestation level, is eliminated in the method according to the invention. It is remarkable, and extremely valuable for practical conditions, that successful control of harmful rodents is possible while relying entirely on the data of the distribution of certain agricultural structural elements which are independent of the infestation.

When testing this method, it emerged, surprisingly, that an eradication of the infestation was possible even on those premises which have suffered massive rat problems over past years despite constantly carrying out control measures. This was even entirely unexpected in a case where the use of anticoagulant baits appeared to be hopeless owing to resistance. In the specific case, this is unexpected in particular because a control product with a first-generation anticoagulant, which according to previous experience had been considered largely ineffective, was employed.

A further advantage of the above-described method is that it can be carried out even when specialists cannot access the premises. This is particularly important under the aspect of planning for emergencies in the event of epidemics, since the premises may not be accessed by outside persons, but control of the harmful rodents is still required.

The method of controlling rats according to the invention is based on a mechanistic procedure which requires no analysis of the infestation level, only knowledge of the distribution of certain structural elements on the agricultural premises in question.

One bait station is set up per structural element: if necessary, it is also possible to set up several bait stations or to combine bait stations close to one another (no more than 3 m apart).

The following are considered important structural elements to be provided with a bait station: buildings, animal keeping, feed stores, stacks (timber, building material and the like), piles of old materials (junk), straw/hay, ground-cover plants (for example shrubs), holes inhabited by harmful rodents, watercourses. It is particularly recommended to take into consideration: animal keeping, feed silo/blender, stacks (timber, building materials and the like), straw/hay. The following structural elements must be equipped with at least one bait: buildings, animal keeping, feed stores, stacks, piles of old materials, straw/hay. In addition, the following should be equipped: ground-cover plants, watercourses, holes inhabited by harmful rodents.

It is suitable to show and distribute these structural elements in a positional sketch, which is done by hand in the simplest of cases. Such a sketch is particularly suitable if drawn by means of electronic media which have suitable symbols available. Most suitable is an interactive computer program which supports the distribution of the bait stations.

All types of rodenticidal feed baits may be used. Recommended are those which are based on cereals, such as flaked oats, or wheat, maize and the like. Particularly recommended are pasty baits which consist of cereals or meals and vegetable fat. Most suitable are pasty baits in packages of from 10 g to 200 g which contain an anticoagulant.

Active compounds which are suitable are stomach poisons, preferably anticoagulants from the group of the 1^{st} and 2^{nd} generation indanedione derivatives or the hydroxycoumarins. These substances are used worldwide for the control of rodents (cf., for example, DE 2506769; JP 48023942; CH 481580; Tammes et al. (1967): Acta Physiol. Pharmacol. 14 P. 423-433; Paposci (1974): Beihefte Z. Angew Zool. P. 155 and DE 2506769). Examples of anticoagulants are the 4-hydroxycoumarin derivatives (1-phenyl-2-acetyl)-3-ethyl-4-hydroxycoumarin (“warfarin”), 3-(α-acetonyl-4-chlorobenzyl)-4-hydroxycoumarin (“coumachlor”), [3-(4′-hydroxy-3′-coumarinyl)-3-phenyl-1-(4′-bromo-4′-biphenyl)-propan-1-ol (“bromadiolone”), 3-(3′-paradiphenylyl-1′,2′,3′,4′-tetrahydro-1′-naphthyl)-4-hydroxycoumarin (“difenacoum”) brodifacoum, flocoumafen and 3-(1′,2′,3′,4′-tetrahydro-1′-naphthyl)-4-hydroxy-coumarin (“coumatetralyl”), the indanedione derivatives, such as 1,1-diphenyl-2-acetylindane-1,3-dione (“diphacinone”) and (1′-p-chlorophenyl-1′-phenyl)-2-acetylindane-1,3-dione (“chlorodiphacinone”) and the hydrocy-4-benzothiopyranones, for example difethialone.

The following 2-azacycloalkylmethyl-substituted benzhydryl ketones and carbinols may be mentioned as further anticoagulants which are suitable for the preparation of the baits according to the invention: 1-phenyl-3-(2-piperidyl)-1-(p-tolyl)-2-propanone, 3,3-diphenyl-1-(2-pyrrolidinyl)-2-pentanone, 1,1-diphenyl-3-[2-(hexahydro-1H-azepinyl)]-2-propanone, 1-(4-fluorophenyl)-1-phenyl-3-(2-piperidyl)-2-propanone, 1-(4-methylthiophenyl)-1-phenyl-3-(5,5-dimethyl-2-pyrrolidinyl)-2-propanone, 1-(p-coumenyl)-1-phenyl-3-(4-tert-butyl-2-piperidinyl)-2-propanone, 3,3-diphenyl-1-[2-(hexahydro-1H-azepinyl]-2-butanone, 3-(2,4-dichlorophenyl)-3-phenyl-1-(2-piperidyl)-2-heptanone, 1,1-diphenyl-3-(5-methyl-2-pyrrolidinyl)-2-propanone, 3,3-diphenyl-1-(2-piperidyl)-2-butanone, α-(α-methyl-α-phenylbenzyl)-2-piperidinylethanol, α-(α-ethyl-α-phenylbenzyl)-2-pyrrolidinylethanol, (2,5-dimethyl-α-phenylbenzyl)-2-piperidinyl ethanol and α-(diphenylmethyl)-2-(hexa-hydro-1H-azepinyl)ethanol and their salts, which are described in DT-OS 2 417 783, and 4′-(fluorophenyl)-2-(2-pyrrolidinyl)acetophenone, 4′-phenyl-2-(5,5-dimethyl-2-pyrrolidinyl)acetophenone, 4′-[p-(trifluoromethyl)phenyl]-2-(2-piperidyl)acetophenone, 4′-(p-butoxyphenyl)-2-(4-tert-butyl-2-piperidyl)acetophenone, 2′-phenoxy-2-(2-piperidyl)acetophenone, 4′-(p-fluorophenoxy)-2-(5,5-dimethyl-2-pyrrolidinyl)acetophenone, 4′-(p-chlorophenoxy)-2-(2-piperidyl)acetophenone, 4′[m-(trifluoromethyl)phenoxy]-2-(2-piperidyl)acetophenone, 4′-(p-butoxyphenoxy)-2-(2-pyrrolidinyl)acetophenone, 2-(2-piperidyl)-4′-(trans-p-tolylvinylene)acetophenone, 2-(2-hexahydro-1H-azepinyl)-4′-(trans-styryl)acetophenone, 4′-(m-methoxyphenyl-vinylene)-2-(2-pyrrolidinyl)acetophenone, 2-(2-piperidyl)-4′-[(p-methylthio)phenyl-vinylene]acetophenone, 4′-(3-phenoxypropoxy)-2-(2-piperidyl)acetophenone, 4′-(4-phenylbutyl)-2-(2-piperidyl)acetophenone, 4′-(α,α-dimethylbenzyl)-2-(piperidyl)acetophenone, 4′-phenethyl-2-(3,5-diethyl-2-piperidyl)acetophenone, 4′-phenyl-2-(2-pyrrolidinyl)acetophenone, α-[2-(2-phenylethoxy)phenyl]-2-piperidinyl-ethanol, α-(p-phenoxyphenyl)-2-pyrrolidinylethanol, α-[4-(4-bromophenoxy)phenyl]-6-methyl-2-piperidinylethanol, α-(p-phenethyl)phenyl-2-pyrrolidinylethanol, α-p-bisphenyl-2-hexanhydro-1H-azepinylethanol, α-[3-(4-phenoxybutoxy)phenyl]-2-piperidinylethanol and α-(4-benzyl)phenyl-2-piperidinylethanol and their salts (cf. DE-A-2 418 480).

The following rare-earth metal salts may likewise be used as anticoagulant: dineodymium hydroxybenzenedisulfonate (Acta physiol. Acad. Sci. Hungar. 24, 373), dineodymium 3-sulfonatopyridine-4-carboxylate and cerium(III) tris-(4-aminobenzenesulfonate).

Other rodenticidal active substances may furthermore be used in the above-described system, for example acute rodenticides (“acute poisons”), for example alpha-chloralose, alpha-naphthylthiourea, N-methyl-2,4-dinitro-N(2,4,6-tribromophenyl)-6-(trifluoromethyl)benzamine (“bromethalin”), vitamins D₂ and D₃ (calciferol, cholecalciferol), (2-chloro-4-dimethylamino-6-methylpyrimidine (“crimidin”), 0,0-bis(p-chlorophenyl)acetimidoylphosphoramidothioate, sodium monofluoroacetate, N-3-pyridylmethyl N′-p-nitrophenylurea (“pyriminyl”), 3,4,5-trimethoxybenzoyl methyl-reserpate (“reserpine”), thallium sulfate, zinc phosphide.

A preferred embodiment of the method according to the invention will be described at this place to illustrate the invention in greater detail:

### EXAMPLE

### 1. Carrying Out the Method According to the Invention

### Preparation:

Provide a sufficient amount of high-grade, fresh bait.
Draw a positional map of the premises with all structural elements using the given symbols, in each case for outdoor premises/ground floor, for upper storeys of the buildings and for basements of the buildings. Also mark small accumulations of old materials.
Mark known rat holes.
Aids: Positional map, table, writing material, bait, if appropriate bait boxes, beaker or small shovel for bulk bait.

### First Bait Placement

Set up a bait station at each position marked by a symbol on the positional map and number it on the map.
Pick up bait (gloves mandatory) and place on something dry and clean, for example a saucer.
Use 2 paste sachets of 100 g each, or 2 beakers (approx. 200 g) per bait station.
Enter bait stations, amounts and dates into the table.

### Restocking

Check all bait stations twice weekly.
If all of the bait in the station has been eaten, put down twice the amount (for example 4 paste sachets). Leave no bait station unstocked!
If some of the bait station has been eaten, make up the missing quantity.
Replace soiled bait.
After 2 weeks, reduce amount of bait at stations which have been left untouched.
Enter the restocked amounts (for example number of sachets) in the table.

### Control/Success/Conclusion

Carry out the control measures until bait is no longer consumed, for a maximum of 2 months after the first placement.
If residual activity at the bait stations persists, check the result of the control measures as follows:

| | Number of stations with signs of feeding | | |
|---|---|---|---|
| | at the end of the last treatment week | | |
| Number of | | Excellent | Moderate |
| bait stations | Eradication | success | success |
| Up to 10 | 0 | 1 | 2 |
| 11-20 | 0 | 2 | 4 |
| >20 | 0 | 3-5 | 6-10 |

If, after 2 months, the treatment is insufficiently successful, all bait stations are provided with feed baits containing a different active compound.

### Documentation

The procedure for carrying out the control measures is documented twice weekly. The tables are kept in a safe place. They serve as a reminder when control methods are carried out in the future, and as documents for the veterinary surgeon or officials regarding legal provisions and statutory regulations regarding epidemics (SchweinehaltungshygVO, [German pig-keeping hygiene regulation], TierSeuchG [German Animal Epidemics Act] and the like).

### 2. Results

Rats were controlled on 25 agricultural premises.

The infestation was eradicated on 18 premises. These premises had set up bait stations at least 81% of the intended structural elements.

The rat infestation was not eradicated on 7 premises. These premises had set up bait stations at only 51% of the intended structural elements.

The rats were controlled under otherwise identical conditions on the 25 premises.

TABLE 1
Result as a function of the closeness with which the
method according to the invention was followed

| Intended bait | Number of | Success of the |
|---|---|---|
| stations set up | agricultural premises | control measures |
| 81% | 18 | =100% (complete |
| | | eradication) |
| 51% | 7 | <95% (no |
| | | eradication) |

TABLE 2
Number of the various structural elements and their equipment with bait stations in (% B) result.

| | | | | Animal | | | | Ground- | | | | Straw/ | | Old | |
|---|---|---|---|---|---|---|---|---|---|---|---|---|---|---|---|
| Result | | Building | | keeping | | Feed | | cover plants | | Stacks | | hay | | materials | |
| | n | n | % B | n | % B | n | % B | n | % B | n | % B | n | % B | n | % B |
| yes | 18 | 116 | 76 | 49 | 86 | 60 | 78 | 10 | 100 | 19 | 95 | 23 | 83 | 29 | 90 |
| no | 7 | 51 | 51 | 21 | 52 | 27 | 67 | 6 | 50 | 13 | 54 | 11 | 64 | 17 | 29 |
| | P | | 0.029 | | 0.448 | | 0.108 | | 0.230 | | 0.073 | | 0.270 | | 0.023 |

Error probability P to Mann-Whitney Test.

### KEY TO THE FIGURES

FIG. 1 shows the symbols used for the various structural elements.
(a) buildings
(b) animal keeping
(c) feed stores
(d) stacks
(e) piles of old materials
(f) straw/hay
(g) ground-cover vegetation
(h) watercourses
(i) holes inhabited by harmful rodents
(k) numbered bait station

FIG. 2 shows a positional plan of agricultural premises for outside areas and ground floor; the structural elements and bait stations are marked.

FIG. 3 shows the matching positional plan for the upper storey; the structural elements and bait stations are shown.

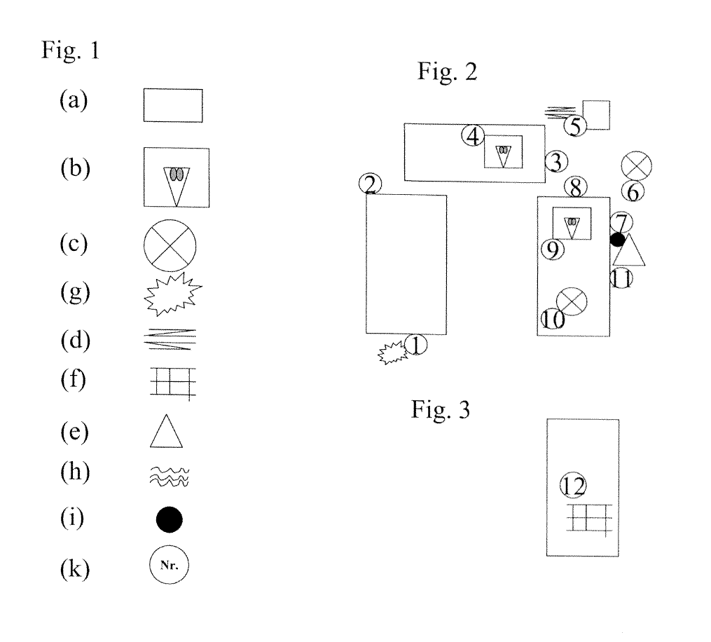

1. A method for controlling harmful rodents on agricultural premises, the method comprising:
identifying one or more structural elements on the agricultural premises, and
setting at least one bait station comprising bait in or about each of the identified structural elements independent of any visible infestation at the structural elements,
wherein an interactive computer program is used to support identifying the structural elements and setting the bait station.

2. The method of claim 1, further comprising marking the identified structural elements on a positional sketch.

3. The method of claim 2, further comprising:
assigning a bait station to each of the marked structural elements,
listing the assigned bait stations in a table on a datasheet, and
recording an amount of bait set at each station.

4. The method of claim 3, wherein the interactive computer program is further used to support marking the identified structural elements on the positional sketch, assigning the bait station to each of the marked structural elements, listing the assigned bait stations in the table on the datasheet, and recording the amount of bait set at each station.

5. A method for controlling harmful rodents on agricultural premises, the method comprising:
identifying one or more structural elements on the agricultural premises, and
setting at least one bait station comprising bait in or about each of the identified structural elements independent of any visible infestation at the structural elements.

6. The method of claim 5, further comprising marking the identified structural elements on a positional sketch.

7. The method of claim 6, further comprising:
assigning a bait station to each of the marked structural elements,
listing the assigned bait stations in a table on a datasheet, and
recording an amount of bait set at each station.

8. The method of claim 5, further comprising inspecting the bait stations every 2 to 7 days.

9. The method of claim 5, further comprising modifying the bait stations by:
increasing an amount of bait when at leas 50% of the bait is eaten, and
replacing the bait with fresh bait when less than 50% of the bait is eaten.

10. The method of claim 5, wherein bait stations which are within about three meters are combined into one bait station.

11. The method of claim 5, wherein the harmful rodents are rats.

12. The method of claim 5, wherein the bait comprises an anticoagulant.

13. The method of claim 12, wherein the anticoagulant is a first-generation anticoagulant.

14. The method of claim 5, wherein identifying and setting at least one bait station are carried out when specialists cannot access the premises.

15. The method of claim 5, wherein the bait stations are only set in or about the identified structural elements.

16. A method for controlling harmful rodents on agricultural premises, the method comprising:
identifying one or more structural elements on the agricultural premises, and
setting at least one bait station in or about each of the identified structural elements without analyzing the infestation level of the harmful rodents.

17. The method of claim 16, further comprising marking the identified structural elements on a positional sketch.

18. The method of claim 17, further comprising:
assigning a bait station to each of the marked structural elements,
listing the assigned bait stations in a table on a datasheet, and
recording an amount of bait set at each station.

19. The method of claim 16, wherein an interactive computer program is used to support identifying the structural elements and setting the bait station.

20. The method of claim 18, wherein the interactive computer program is used to support identifying the structural elements, setting the bait station, marking the identified structural elements on the positional sketch, assigning the bait station to each of the marked structural elements, listing the assigned bait stations in the table on the datasheet, and recording the amount of bait set at each station.
